(19) United States
(12) Patent Application Publication
(10) Pub. No.: US 2024/0037248 A1
(43) Pub. Date: Feb. 1, 2024

(54) ARTIFICIAL INTELLIGENCE ARCHITECTURE FOR MANAGING MULTI-STAGE PROCESSES

(71) Applicant: Avanade, Chicago, IL (US)

(72) Inventor: Gnana Geetha GANDHI, Tampa, FL (US)

(21) Appl. No.: 18/360,293

(22) Filed: Jul. 27, 2023

Related U.S. Application Data
(60) Provisional application No. 63/369,869, filed on Jul. 29, 2022.

(51) Int. Cl. G06F 21/57

(52) U.S. Cl. CPC G06F 21/577; G06F 2221/034

(57) ABSTRACT

In some implementations, a device may register a first set of monitoring sensors associated with monitoring an entity. The device may receive, from the first set of monitoring sensors, and based on registering the first set of monitoring sensors, a set of sensor measurements of the entity during a monitoring period. The device may generate a prediction for an event associated with the entity. The device may transmit a first set of alerts associated with the event. The device may receive a set of tracking updates based on transmitting the set of alerts associated with the event. The device may register a set of attributes in a distributed ledger based on receiving the set of tracking updates. The device may transmit a second set of alerts associated with the distributed ledger based on registering the set of attributes in the distributed ledger.

### CROSS-REFERENCE TO RELATED APPLICATION

This patent application claims priority to U.S. Provisional Patent Application No. 63/369,869, filed on Jul. 29, 2022, and entitled “ARTIFICIAL INTELLIGENCE ARCHITECTURE FOR MANAGING MULTI-STAGE PROCESSES.” The disclosure of the prior application is considered part of and is incorporated by reference into this patent application.

### BACKGROUND

In an increasingly connected world, a computer system for managing operations of different devices (e.g., supply chain devices, healthcare devices, or transaction devices) may communicate with many different proprietary systems, leading to challenges in interoperability, efficiency, and scalability. Some enterprise systems for managing the operations of the different devices are configured to implement multiple interfaces, protocols, and adapters to facilitate communication between the enterprise system and various proprietary systems, resulting in complex and fragmented architectures.

### SUMMARY

Some implementations described herein relate to a method. The method may include registering, by a device, a first set of monitoring sensors associated with monitoring an entity. The method may include receiving, by the device and from the first set of monitoring sensors, and based on registering the first set of monitoring sensors, a set of sensor measurements of the entity during a monitoring period. The method may include generating, by the device and based on the set of sensor measurements, a prediction for an event associated with the entity. The method may include transmitting, by the device, a first set of alerts associated with the event. The method may include receiving, by the device and from a second set of monitoring sensors, a set of tracking updates based on transmitting the set of alerts associated with the event. The method may include registering, by the device, a set of attributes, associated with the entity and the set of tracking updates, in a distributed ledger based on receiving the set of tracking updates. The method may include transmitting, by the device, a second set of alerts associated with the distributed ledger based on registering the set of attributes in the distributed ledger.

Some implementations described herein relate to a method. The method may include registering, by a device, a first set of monitoring sensors associated with monitoring an entity. The method may include registering, by the device, a set of client devices associated with outputting information associated with the entity. The method may include receiving, by the device and from the set of monitoring sensors, a set of sensor measurements of the entity during a monitoring period based on registering the set of monitoring sensors. The method may include generating, by the device, a prediction for an event associated with the entity based on the set of sensor measurements. The method may include transmitting, by the device and to the set of client devices, a first set of alerts associated with the event. The method may include registering, by the device, anonymized data associated with the event in a database storing data associated with other events associated with other entities. The method may include transmitting, by the device, a second set of alerts associated with the database based on registering the anonymized data in the database.

Some implementations described herein relate to a method. The method may include registering, by a device, a processing device associated with facilitating processing of a record. The method may include receiving, by the device, a request to process the record based on registering the processing device. The method may include obtaining, by the device, data identifying a set of attributes of the record based on receiving the request to process the record. The method may include generating, by the device, a fraud prediction based on the data identifying the set of attributes. The method may include processing, by the device, the record based on the fraud prediction. The method may include transmitting, by the device, a set of alerts associated with processing the record.

### BRIEF DESCRIPTION OF THE DRAWINGS

FIGS. 1A-1C are diagrams of an example implementation associated with using an artificial intelligence architecture for managing multi-stage processes.

FIG. 2 is a diagram illustrating an example of training and using a machine learning model in connection with using an artificial intelligence architecture for managing multi-stage processes.

FIG. 3 is a diagram of an example environment in which systems and/or methods described herein may be implemented.

FIG. 4 is a diagram of example components of a device associated with using an artificial intelligence architecture for managing multi-stage processes.

FIGS. 5-7 are flowcharts of example processes associated with using an artificial intelligence architecture for managing a multi-stage process.

### DETAILED DESCRIPTION

The following detailed description of example implementations refers to the accompanying drawings. The same reference numbers in different drawings may identify the same or similar elements.

The Internet of Things (IoT) has resulted in a vast increase in the quantity of connected devices that are deployed to perform tasks for a backend system. For example, a healthcare system architecture may include medical devices, medical sensors, client devices (e.g., computers), mobile devices, medical wearable devices, and many other devices that can collect data for processing, provide data for viewing, or perform actions. Similarly, a supply chain system architecture may include sensors (e.g., for monitoring growth of a food product or monitoring progress of a manufactured product), tracking devices (e.g., for monitoring a location of an item within a supply chain), input devices (e.g., bar code scanners), client devices, or mobile devices, among other examples. Further, a payment processing system architecture may include point-of-sale devices, transaction processing devices, payment systems, routing systems, mobile devices, or client devices, among other examples.

With the increasing quantities of devices and systems that can be integrated in a single architecture, fragmentation can occur. For example, a first system or device within a single architecture may not be able to communicate with a second system or device within the single architecture without establishment of complex interfaces, protocols, or adapters, among other examples. As a result, data is increasingly siloed, which can prevent execution of multi-step processes that integrate data from many different source devices, such as monitoring sensors, backend systems, or other data structures.

Some aspects described herein provide an artificial intelligence (AI) architecture for managing multi-stage processes. For example, a backend system can interact with a wide variety of data sources to obtain data, perform AI-based analyses of the data, and control multi-step processes associated with different use cases, such as supply chain management use cases, healthcare use cases, or payment platform use cases, among other examples. By providing a unified architecture that integrates AI services, the backend system enables improved efficiency and/or improved outcomes for multi-stage processes that are managed via the unified architecture. For example, the unified architecture may enable improved efficiency in supply chain management of agricultural products (e.g., food) that are distributed via a complex supply chain. Additionally, or alternatively, the unified architecture may improve patient outcomes and/or reduce a time to complete clinical trials by integrating data from a variety of sources to perform predictions relating to diagnosis, treatment, and/or data analysis. Additionally, or alternatively, the unified architecture may reduce fraud and/or other security risks associated with payment processing by enabling improved evaluation of contextual data to determine whether to approve payment or other transaction requests.

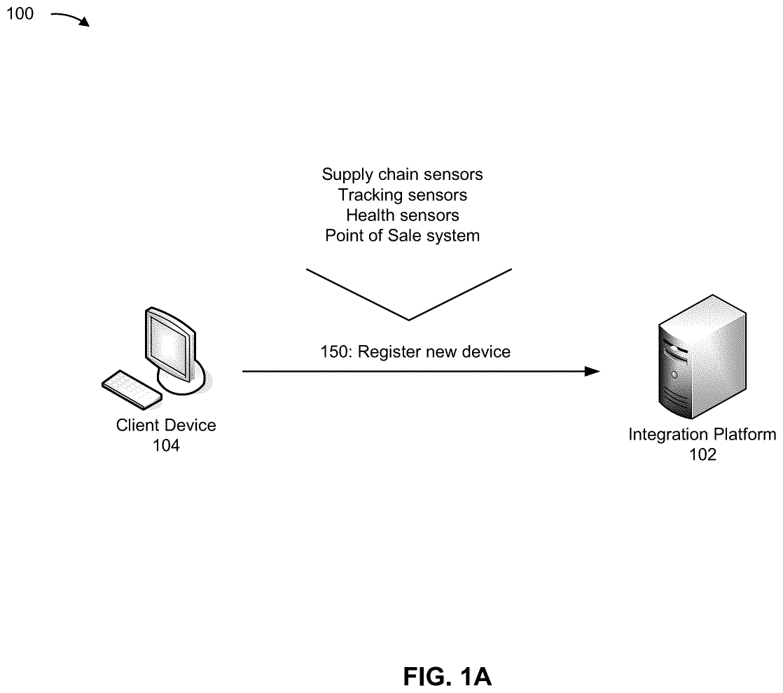

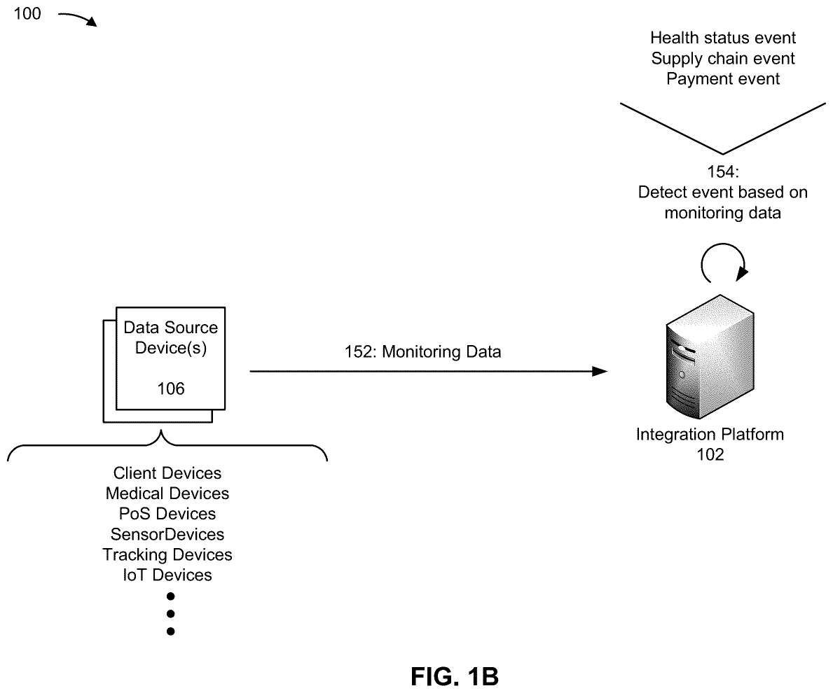

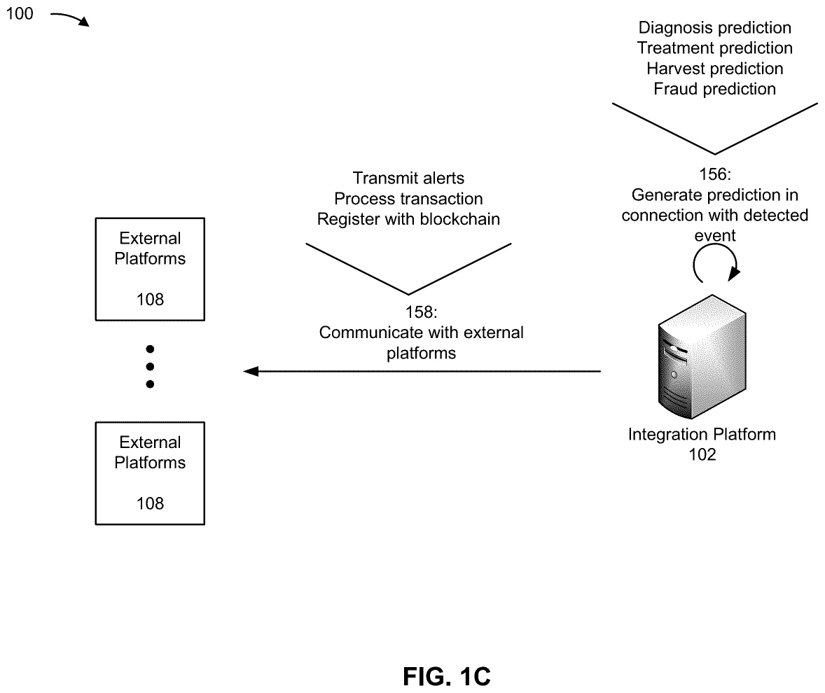

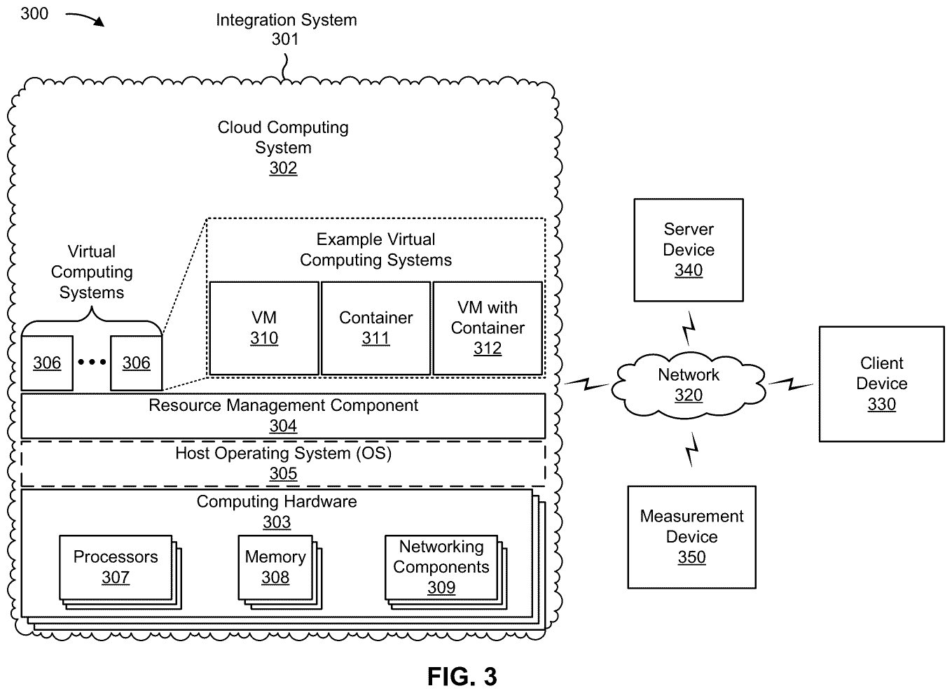

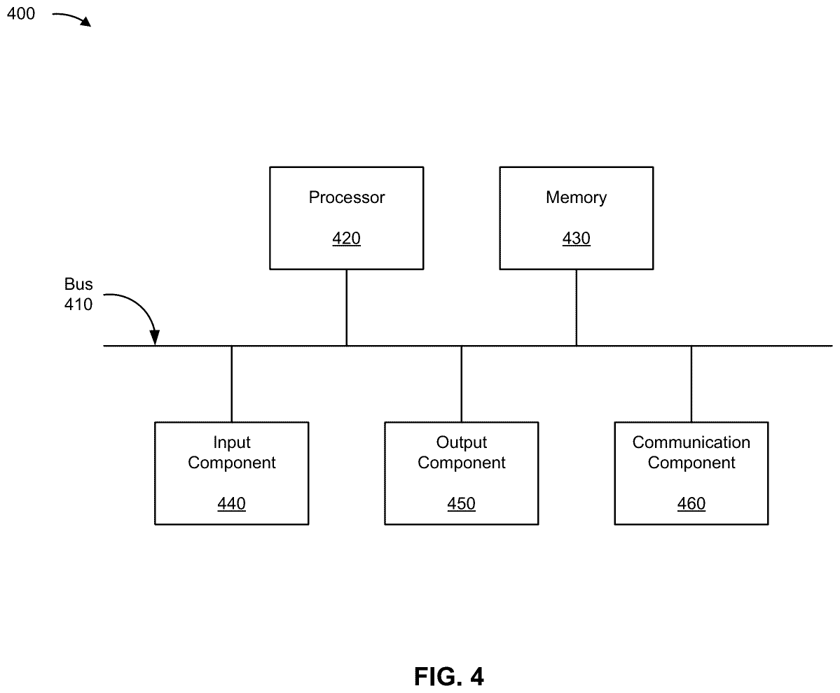

FIGS. 1A-1C are diagrams of an example implementation 100 associated with using an artificial intelligence architecture for managing multi-stage processes. As shown in FIGS. 1A-1C, example implementation 100 includes an integration platform 102, a client device 104, a set of data sources 106, and a set of external platforms 108. These devices are described in more detail below in connection with FIG. 3 and FIG. 4.

As further shown in FIG. 1A, and by reference number 150, the integration platform 102 may register one or more new devices. For example, the integration platform 102 may receive a request, from the client device 104, to register a set of measurement sensors, such as a set of supply chain sensors, a set of tracking sensors, a set of health sensors, or a set of point of sale (POS) systems. For example, in a supply chain context associated with growing and distributing farm products, the integration platform 102 may receive a request to register a set of temperature sensors, humidity sensors, light sensors, cameras, or location tracking sensors, among other examples. Additionally, or alternatively, in a healthcare context associated with treating patients and/or managing clinical studies, the integration platform 102 may receive a request to register a set of health applications or devices (e.g., consumer medical devices), a set of specialized medical devices (e.g., non-consumer medical devices), a set of health records storage platforms, or a set of messaging devices (e.g., mobile devices, medical display systems, physician paging system devices, etc.), among other examples. Additionally, or alternatively, in a payment processing platform context or other transactional context, the integration platform 102 may receive a request to register a set of POS devices, a set of payment devices (e.g., mobile devices that can provide payment information using, for example, near-field communication (NFC) protocols), an eWallet device, a digital credit card device, or a payment processing backend system, among other examples.

In some implementations, the integration platform 102 may generate a digital representation of a new device when registering the new device. For example, the integration platform 102 may generate a digital twin that represents the new device in an IoT hub and includes information associated with identifying a set of services associated with the new device, a configuration of the new device, or an application programming interface (API) that can be used to communicate with the new device, among other examples. In this case, the integration platform 102 may associate device metadata of the new device (e.g., the information identifying the services, configurations, etc.) with the digital twin to enable the digital twin to simulate behavior of the new device. In some implementations, digital twins may be aggregated to form another digital twin. For example, the integration platform 102 may generate a digital twin of a location (e.g., a farm or a field thereof) by aggregating digital twins of multiple sensors associated with the location. Similarly, in another context, the integration platform 102 may generate a digital twin of a patient by aggregating digital twins of sensors monitoring the patient to enable simulation of a candidate treatment (e.g., when using AI techniques to predict a best treatment for a predicted condition).

Additionally, or alternatively, the integration platform 102 may containerize one or more software units in connection with the new device or provide the new device with access to one or more containerized software units. In some implementations, the integration platform 102 may register the new device with an orchestrator. For example, the integration platform 102 may provide an orchestration functionality for a set of infrastructure-as-code functionalities, software containers, and/or other digital assets. In this case, the integration platform 102 may add the new device to a set of devices and/or functions that can be controlled using the orchestration functionality.

Additionally, or alternatively, the integration platform 102 may generate a compliance profile associated with the new device. For example, the integration platform 102 may identify a compliance standard that is applicable to the new device and may register a parameter associated with controlling data access in accordance with the compliance standard to ensure that the compliance standard is satisfied. Examples of compliance standards that the integration platform 102 may implement may include Payment Card Industry (PCI) Data Security Standard (DSS), Health Insurance Portability and Accountability Act (HIPAA) Protected Health Information (PHI), General Data Protection Regulation (GDPR), Sarbanes-Oxley Act (SOX), California Consumer Privacy Act (CCPA), or International Organization for Standardization (ISO) 27001 Information Security Management Systems Certification, among other examples. Additionally, or alternatively, the integration platform 102 may provide other layers of security to mitigate a risk of data leaks or cyber attacks, thereby securing personal data. For example, each component or software module of the integration platform 102 may implement one or more security techniques to ensure that information is protected from malicious access, which may facilitate satisfying one or more of the abovementioned compliance standards.

In some implementations, the integration platform 102 may set one or more security permissions associated with a new device when registering the new device. For example, the integration platform 102 may identify data to which the new device is to have access and/or data to which the new device is prevented from having access. Additionally, or alternatively, the integration platform 102 may establish one or more secure communication sessions for the new device. For example, the integration platform 102 may establish one or more security keys or tokens to enable secure communications between the new device, the integration platform 102, and/or one or more other devices.

In some implementations, the integration platform 102 may establish one or more event-driven actions in connection with registering a new device. For example, the integration platform 102 may establish a set of channels associated with a set of new devices and may determine threshold values that, if observed, trigger execution of one or more functionalities of the integration platform 102, as described in more detail below. For example, the integration platform 102 may set a threshold measurement that may result in a validation determination, an AI prediction being performed, a security risk assessment, or another functionality.

As further shown in FIG. 1B, and by reference number 152, the integration platform 102 may receive monitoring data. For example, the integration platform 102 may receive monitoring data from one or more data sources 106. The one or more data sources 106 may include the one or more new devices (e.g., a set of measurements sensors) that were registered with the integration platform 102. Additionally, or alternatively, the one or more data sources 106 may include the client device 104, a set of backend systems, a set of databases, or a set of data structures, among other examples.

In some implementations, the integration platform 102 may receive the monitoring data based on registering one or more new devices. For example, when the integration platform 102 registers a set of monitoring sensors, such as a set of agriculture sensors, a set of tracking sensors, a set of healthcare sensors, or a set of POS devices, among other examples, the integration platform 102 may establish one or more data streams for receiving sensor measurements from the set of sensors. In this case, the set of sensor measurements may include temperature measurements, humidity measurements, healthcare status measurements (e.g., patient vitals), images (e.g., for image processing or object recognition), location updates, or POS measurements (e.g., items being scanned for purchase, or payment sources being provided for a transaction). In some implementations, the integration platform 102 may update one or more digital twins based on receiving the monitoring data. For example, the integration platform 102 may use the digital twins to simulate behaviors of monitoring sensors or aggregations of monitoring sensors and generate data for performing predictions or detecting events based on simulating behaviors using the digital twins. When real data is received from the monitoring sensors, the integration platform 102 may update states and/or telemetry of the digital twins, thereby correcting deviations (e.g., that occur during simulation) from real states of the monitoring sensors that the digital twins are simulating.

As further shown in FIG. 1B, and by reference number 154, the integration platform 102 may detect an event based on the monitoring data. For example, the integration platform 102 may detect an event based on information received from the data sources 106. In some implementations, the integration platform 102 may detect an event based on a measurement of the monitoring data satisfying a threshold. Additionally, or alternatively, the integration platform 102 may detect an event based on simulated monitoring data from a digital twin satisfying a threshold. For example, the integration platform 102 may use AI algorithms to simulate behavior of a monitoring sensor or an aggregation of monitoring sensors and may proactively detect an event (e.g., before the event has occurred in real life) based on a result of simulating behavior using the digital twins. This may enable the integration platform 102 to transmit alerts or perform actions in advance of real events occurring, thereby enabling mitigation of the events or real-time responses to the events (when the events occur in real-life) rather than retroactive responses to the events (that can be configured only after the event occurs in real-life and is detected).

In some implementations, the integration platform 102 may determine that a location has changed by a threshold amount and may determine that an item in a supply chain has moved based on the location changing by the threshold amount. Similarly, the integration platform 102 may set a geofence around a location within a supply chain (e.g., a warehouse) and may detect an event when the geofence is triggered (e.g., as a result of location tracking or barcode scanning indicating a location that triggers the geofence). Additionally, or alternatively, the integration platform 102 may establish a threshold level for a healthcare measurement, such as a threshold temperature or a threshold blood oxygenation level, and may detect an event when the threshold is satisfied for a threshold measurement period (e.g., for a threshold quantity of measurements or a threshold number of seconds).

In some implementations, the integration platform 102 may detect an event based on a result of executing an AI algorithm being provided as infrastructure-as-code by the integration platform 102. For example, the integration platform 102 may receive monitoring data and feed the monitoring data into the AI algorithm (or another type of machine learning or predictive algorithm). In this case, in a supply chain context, the AI algorithm may predict an optimal time to harvest an agricultural product (e.g., based on imaging of the product, temperature data, humidity data, a prediction of future weather data, or data relating to an availability of trucks for shipping the agricultural product), which may trigger an event (e.g., to harvest the agricultural product). In another example, in a healthcare context, the AI algorithm may predict a diagnosis of a patient based on medical data. In another example, in a payment processing context, the AI algorithm may predict a risk of fraud based on transaction data. In the aforementioned examples, the integration platform 102 may trigger an event, such as outputting data, causing automated actions to be performed, or performing subsequent predictions using AI algorithms, as described herein.

As further shown in FIG. 1C, and by reference number 156, the integration platform 102 may generate a prediction in connection with the detected event. For example, the integration platform 102 may generate a prediction that is related to the detected event. In one example, in a supply chain context, the integration platform 102 may detect a threshold temperature and may generate a prediction or determination of whether an optimal time to harvest an agricultural product has been reached. Additionally, or alternatively, the integration platform 102 may execute a first AI algorithm to trigger an event of harvesting the agricultural product and may generate a determination, based on the event of harvesting the agricultural product, of which trucks, of a set of available trucks, to deploy to transport the agricultural product. Additionally, or alternatively, the integration platform 102 may generate a determination of an optimal price for existing agricultural products to ensure that the existing agricultural products are sold when new agricultural products are harvested, shipped, and arrive at a store.

In another example, in a healthcare context, the integration platform 102 may detect an event (e.g., that a patient temperature satisfies a threshold) and may generate a prediction of a condition for the patient. Additionally, or alternatively, the integration platform 102 may generate a first prediction (e.g., of a condition) that triggers an event (e.g., to treat the patient) and may generate a second prediction based on the event (e.g., a prediction of a treatment). Additionally, or alternatively, the integration platform 102 may detect an event relating to a single patient (e.g., treatment of the single patient) and may generate a prediction relating to a cohort of patients (e.g., an efficacy of a treatment in a clinical trial). Additionally, or alternatively, the integration platform 102 may generate a prediction of an action to perform, such as a prediction of one or more devices with which to communicate, one or more messages to send, or one or more devices to control in a configured manner (e.g., automatically controlling one or more specialized medical devices or automatically initiating a manufacturing process for a treatment), among other examples.

In another example, in a payment processing context, the integration platform 102 may detect an event (e.g., that a transaction is to occur) and may generate a prediction of whether the transaction is indicative of fraud. In this case, an event may include initiation of a transaction or an attempt to authenticate a user for access to an account (e.g., using a digital identity), among other examples. Additionally, or alternatively, the integration platform 102 may generate a first prediction (e.g., that a transaction is indicative of fraud) associated with an event (e.g., further verification of the transaction) and may generate a second prediction (e.g., of a type of data to obtain to verify whether the transaction is genuine). Additionally, or alternatively, the integration platform 102 may generate a prediction of an action to perform associated with an event (e.g., a change to pricing based on a new level of supply associated with completion of the transaction). In the example of authentication using a digital identity, an identity user may request a digital identity from a digital identity issuer, which may publish digital identity metadata information to a secure data structure or a blockchain. When the identity user attempts to obtain access (e.g., to an account for a transaction or to a physical space), the identity user receives a request to provide a digital identity and prepares and provides the digital identity to an authenticator. The authenticator reads the digital identity metadata information from the secure data structure or the blockchain, verifies the digital identity, and grants access based on verifying the digital identity. In this case, the integration platform 102 (e.g., which may be a backend server acting as or facilitating the digital identity issuer and the authenticator) may generate a determination regarding whether to verify the digital identity (e.g., received from a data source device 160) or reject the digital identity as fraudulent based on the digital identity metadata and/or other available information. The digital identity may be a digital representation of a personal identifier, a ticket, a membership, an access card, a key, a payment card, or another item for a user.

As further shown in FIG. 1C, and by reference number 158, the integration platform 102 may communicate with one or more external platforms 108. For example, the integration platform 102 may communicate with the one or more external platforms 108 to provide information and/or cause an automated action to be performed. In some implementations, the integration platform 102 may communicate with the one or more external platforms 108 to transmit one or more sets of alerts. For example, in a supply chain context, based on generating a first prediction (e.g., to harvest an agricultural product), the integration platform 102 may transmit an alert associated with harvesting the agricultural product (e.g., an instruction that the agricultural product is to be harvested, a request to deploy a refrigerated truck to a farm to pick up and transport the agricultural product, a notification to discount existing agricultural products at a store to make space for the agricultural product, or a notification to order replacement seeds for growing new agricultural products). Additionally, or alternatively, the integration platform 102 may communicate with the one or more external platforms 108 to automatically implement an action (e.g., to cause a robotic harvester to harvest, to cause an autonomous truck to be deployed, to update an IoT device displaying a price of an item, or to complete a transaction, among other examples). In this case, the integration platform 102 may delete a digital twin representing, for example, the agricultural product when the agricultural product is harvested, shipped, and/or sold and may instantiate a new digital twin representing a new agricultural product being grown as a replacement for the agricultural product.

In some implementations, the integration platform 102 may communicate with the one or more external platforms 108 to transmit multiple sets of alerts. For example, after transmitting a first alert to harvest an agricultural product and deploy a truck, the integration platform 102 may receive, from a monitoring sensor, a tracking update identifying a location of the truck as the agricultural product is being delivered. In this case, the integration platform 102 may detect subsequent events (e.g., arrival of the truck at a warehouse or arrival of the product at a store) and transmit subsequent alerts (e.g., a second alert indicating a current location of the product, a provenance of the product, a recall of the product). In some implementations, the integration platform 102 may communicate with the one or more external platforms 108 to update a distributed ledger (e.g., a blockchain) in connection with transmitting an alert. For example, the integration platform 102 may register one or more attributes associated with an entity (e.g., an agricultural product), such as a location of the entity, an origin or provenance of the entity, or an ownership of the entity, among other examples. In this case, when transmitting an alert, the integration platform 102 may use the distributed ledger to obtain verifiable information for the alert. For example, the integration platform 102 may use a blockchain to track purchasing of an agricultural product and may, when transmitting a recall alert, use the blockchain to identify mobile devices to which to transmit the recall alert. In this case, based on using a distributed ledger, the integration platform 102 may more efficiently communicate alerts by transmitting alerts directly to the mobile devices to which the alerts pertain rather than transmitting the alerts to many mobile devices, some of which are not relevant endpoints for the alerts.

In another example, in a healthcare context, the integration platform 102 may transmit, to the one or more external platforms 108, a set of alerts that identify a diagnosis, a treatment plan, or a result of a clinical trial, among other examples. Additionally, or alternatively, the integration platform 102 may transmit multiple sets of alerts, such as transmitting a first set of alerts identifying a diagnosis and a treatment plan, receiving monitoring data during treatment, predicting a new treatment plan, and transmitting a second set of alerts to identify an updated treatment plan. Additionally, or alternatively, the integration platform 102 may transmit a first set of alerts associated with an individual patient to a first external platform 108 and a second set of alerts associated with a set of patients in a clinical trial to a second external platform 108. In this case, the integration platform 102 may register anonymized data associated with the detected event (e.g., the monitoring data, the predicted diagnosis, or the predicted treatment plan) in a database storing data associated with other detected events (e.g., other patients in the same clinical trial). Based on storing the anonymized data in the database, the integration platform 102 may analyze the data to predict a result of a clinical trial, determine that the trial can be declared completed, and may transmit alerts relating to completing the trial (e.g., alerts relating to notifying trial participants, requesting regulatory approval of a treatment, or automatically initiating manufacture of a medicine).

In another example, in a payment processing or transactional context, the integration platform 102 may transmit an alert approving a transaction or indicating a result of a fraud prediction. For example, the integration platform 102 may predict that a transaction is not fraudulent and may communicate with a first set of external platforms 108 to process the transaction. In this case, based on communicating with the first set of external platforms 108 to process the transaction, the integration platform 102 may communicate with a second set of external platforms 108 to transmit a set of alerts indicating successful processing of the transaction or another type of record. Additionally, or alternatively, when the integration platform 102 predicts that a transaction is fraudulent, the integration platform 102 may communicate with one or more external platforms 108 to request further authentication (e.g., two-factor authentication) for completing the transaction and may complete the transaction based on receiving the further authentication.

As indicated above, FIGS. 1A-1C are provided as an example. Other examples may differ from what is described with regard to FIGS. 1A-1C. The number and arrangement of devices shown in FIGS. 1A-1C are provided as an example. In practice, there may be additional devices, fewer devices, different devices, or differently arranged devices than those shown in FIGS. 1A-1C. Furthermore, two or more devices shown in FIGS. 1A-1C may be implemented within a single device, or a single device shown in FIGS. 1A-1C may be implemented as multiple, distributed devices. Additionally, or alternatively, a set of devices (e.g., one or more devices) shown in FIGS. 1A-1C may perform one or more functions described as being performed by another set of devices shown in FIGS. 1A-1C.

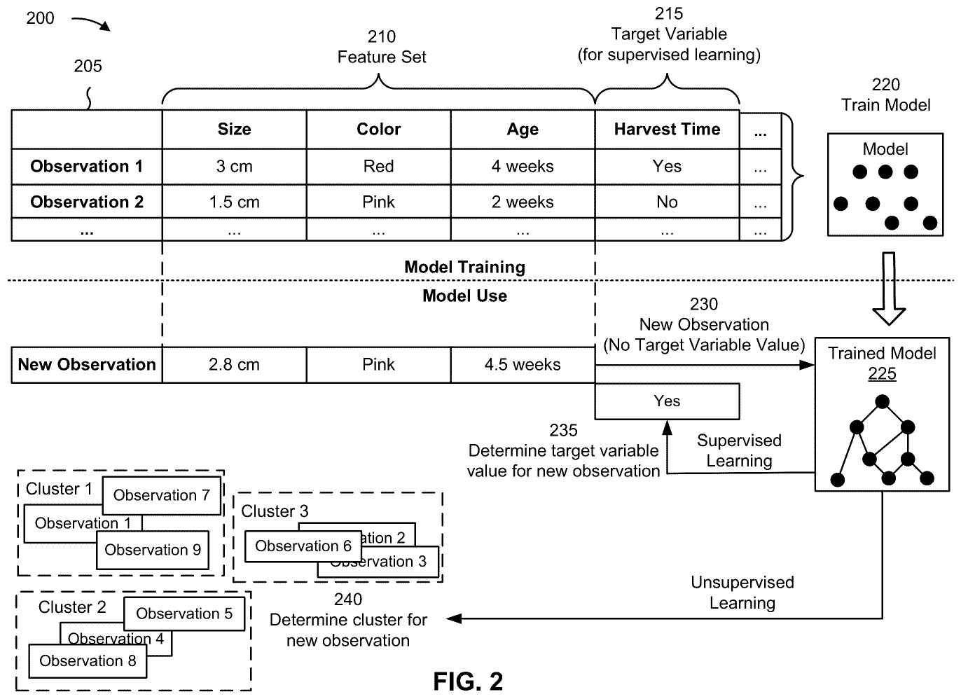

FIG. 2 is a diagram illustrating an example 200 of training and using a machine learning model in connection with using an artificial intelligence architecture for managing multi-stage processes. The machine learning model training and usage described herein may be performed using a machine learning system. The machine learning system may include or may be included in a computing device, a server, a cloud computing environment, or the like, such as the integration system described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from a server device or measurement device, as described elsewhere herein.

As shown by reference number 210, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from a server device or measurement device. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of a size, a second feature of a color, a third feature of an age, and so on. As shown, for a first observation, the first feature may have a value of 3 centimeters (cm), the second feature may have a value of red, the third feature may have a value of 4 weeks, and so on. These features and feature values are provided as examples, and may differ in other examples. For example, the feature set may include one or more of the following features: location, origin, species, crop type, temperature, humidity, or shape, among other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is whether a crop is ready for harvesting, which has a value of yes for the first observation.

The feature set and target variable described above are provided as examples, and other examples may differ from what is described above. For example, for a target variable of a medical diagnosis or a treatment recommendation, the feature set may include health sensor data (e.g., a pulse, a blood oxygenation, a blood sugar level), patient history data (e.g., demographic data, prior treatment data), or medical record data (e.g., large language model data from a medical corpus), among other examples. Additionally, or alternatively, for a target variable of a fraud prediction, the feature set may include credit card data, purchase data, location data, or credit history data, among other examples.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. For example, the machine learning system may use a decision tree algorithm to determine whether to approve a transaction or deny a transaction (e.g., in connection with a fraud prediction). Additionally, or alternatively, the machine learning system may use a support vector machine algorithm to classify a patient into a particular grouping associated with a particular condition (e.g., a diagnosis) or a particular treatment. Additionally, or alternatively, the machine learning system may use a neural network algorithm to predict whether a particular time is an optimal time for harvesting a crop or producing an item for distribution via a supply chain. After training, the machine learning system may store the machine learning model as a trained machine learning model 225 to be used to analyze new observations.

As an example, the machine learning system may obtain training data for the set of observations based on monitoring a set of measurement devices, such as a set of crop sensors, a set of tracking devices, a set of healthcare monitoring devices, a set of healthcare tracking databases, or a set of point-of-sale devices, among other examples.

As shown by reference number 230, the machine learning system may apply the trained machine learning model 225 to a new observation, such as by receiving a new observation and inputting the new observation to the trained machine learning model 225. As shown, the new observation may include a first feature of a size, a second feature of a color, a third feature of an age, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of yes for the target variable of whether to harvest a crop for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, harvesting the corp. The first automated action may include, for example, initiate a set of supply chain actions, as described in more detail herein.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a particular medical condition), then the machine learning system may provide a first recommendation, such as a particular treatment recommendation. Additionally, or alternatively, the machine learning system may perform a first automated action and/or may cause a first automated action to be performed (e.g., by instructing another device to perform the automated action) based on classifying the new observation in the first cluster, such as enrolling a patient in a clinical trial relating to the particular medical condition.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model). For example, the feedback information may include evaluations of crop ripeness, follow-up patient data, or fraud tracking data, among other examples.

In this way, the machine learning system may apply a rigorous and automated process to provide predictions in connection with multi-step processes. The machine learning system may enable recognition and/or identification of tens, hundreds, thousands, or millions of features and/or feature values for tens, hundreds, thousands, or millions of observations, thereby increasing accuracy and consistency and reducing delay associated with providing predictions in connection with multi-step processes relative to requiring computing resources to be allocated for tens, hundreds, or thousands of operators to manually perform predictions using the features or feature values.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include a integration system 301, which may include one or more elements of and/or may execute within a cloud computing system 302. The cloud computing system 302 may include one or more elements 303-312, as described in more detail below. As further shown in FIG. 3, environment 300 may include a network 320, a client device 330, a server device 340, and/or a measurement device 350. Devices and/or elements of environment 300 may interconnect via wired connections and/or wireless connections.

The cloud computing system 302 may include computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

The computing hardware 303 may include hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, and/or one or more networking components 309. Examples of a processor, a memory, and a networking component (e.g., a communication component) are described elsewhere herein.

The resource management component 304 may include a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 310. Additionally, or alternatively, the resource management component 304 may include a container manager, such as when the virtual computing systems 306 are containers 311. In some implementations, the resource management component 304 executes within and/or in coordination with a host operating system 305.

A virtual computing system 306 may include a virtual environment that enables cloud-based execution of operations and/or processes described herein using computing hardware 303. As shown, a virtual computing system 306 may include a virtual machine 310, a container 311, or a hybrid environment 312 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

Although the integration system 301 may include one or more elements 303-312 of the cloud computing system 302, may execute within the cloud computing system 302, and/or may be hosted within the cloud computing system 302, in some implementations, the integration system 301 may not be cloud-based (e.g., may be implemented outside of a cloud computing system) or may be partially cloud-based. For example, the integration system 301 may include one or more devices that are not part of the cloud computing system 302, such as device 400 of FIG. 4, which may include a standalone server or another type of computing device. The integration system 301 may perform one or more operations and/or processes described in more detail elsewhere herein.

The network 320 may include one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The client device 330 may include one or more devices capable of receiving, generating, storing, processing, and/or providing information associated with using an artificial intelligence architecture for managing multi-stage processes, as described elsewhere herein. The client device 330 may include a communication device and/or a computing device. For example, the client device 330 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The server device 340 may include one or more devices capable of receiving, generating, storing, processing, providing, and/or routing information associated with using an artificial intelligence architecture for managing multi-stage processes, as described elsewhere herein. The server device 340 may include a communication device and/or a computing device. For example, the server device 340 may include a server, such as an application server, a client server, a web server, a database server, a host server, a proxy server, a virtual server (e.g., executing on computing hardware), or a server in a cloud computing system. In some implementations, the server device 340 may include computing hardware used in a cloud computing environment.

The measurement device 350 may include one or more wired or wireless devices capable of receiving, generating, storing, transmitting, processing, detecting, and/or providing information associated with using an artificial intelligence architecture for managing multi-stage processes, as described elsewhere herein. For example, the measurement device 350 may include a temperature sensor, a moisture sensor, a humidity sensor, an accelerometer, a gyroscope, a proximity sensor, a light sensor, a noise sensor, a pressure sensor, an ultrasonic sensor, a smoke sensor, a gas sensor (e.g., a carbon monoxide sensor, an oxygen sensor, and/or a carbon dioxide sensor), a chemical sensor, an alcohol sensor, a positioning sensor, a capacitive sensor, a timing device, an infrared sensor, an active sensor (e.g., a sensor that requires an external power signal), a passive sensor (e.g., a sensor that does not require an external power signal), a biological sensor, a radioactive sensor, a magnetic sensor, an electromagnetic sensor, an analog sensor, and/or a digital sensor, among other examples. The measurement device 350 may sense or detect a condition or information and transmit, using a wired or wireless communication interface, an indication of the detected condition or information to other devices in the environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400 associated with using an artificial intelligence architecture for managing multi-stage processes. The device 400 may correspond to integration system 301, client device 330, server device 340, and/or measurement device 350. In some implementations, integration system 301, client device 330, server device 340, and/or measurement device 350 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

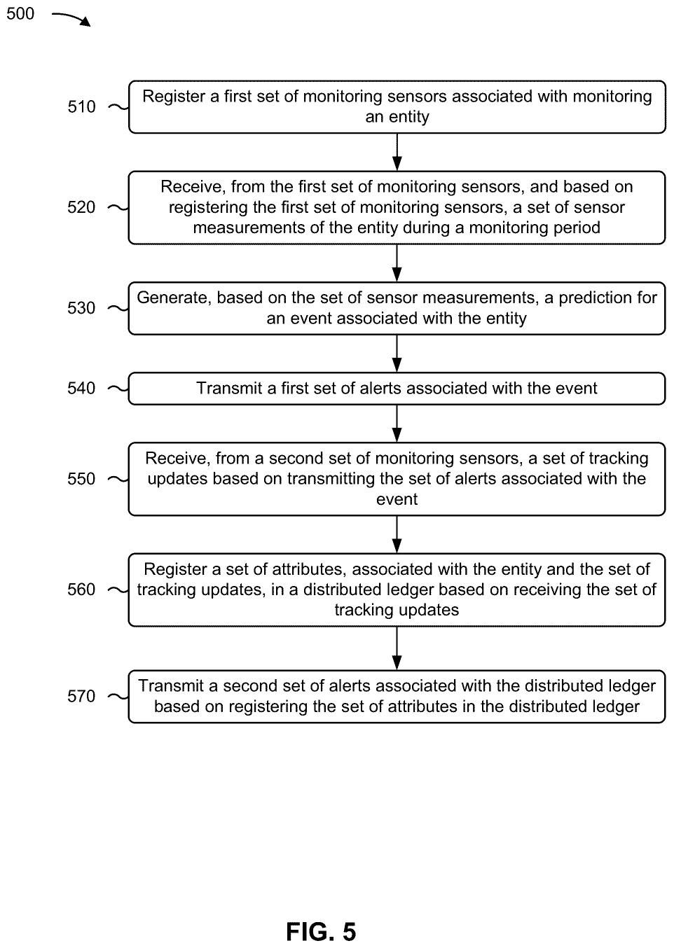

FIG. 5 is a flowchart of an example process 500 associated with using an artificial intelligence architecture for managing a multi-stage process. In some implementations, one or more process blocks of FIG. 5 are performed by a device (e.g., the integration system 301). In some implementations, one or more process blocks of FIG. 5 are performed by another device or a group of devices separate from or including the device, such as a client device (e.g., the client device 330), a server device (e.g., the server device 340), and/or a measurement device (e.g., the measurement device 350). Additionally, or alternatively, one or more process blocks of FIG. 5 may be performed by one or more components of device 400, such as processor 420, memory 430, input component 440, output component 450, and/or communication component 460.

As shown in FIG. 5, process 500 may include registering a first set of monitoring sensors associated with monitoring an entity (block 510). For example, the device may register a first set of monitoring sensors associated with monitoring an entity, as described above.

As further shown in FIG. 5, process 500 may include receiving, from the first set of monitoring sensors, and based on registering the first set of monitoring sensors, a set of sensor measurements of the entity during a monitoring period (block 520). For example, the device may receive, from the first set of monitoring sensors, and based on registering the first set of monitoring sensors, a set of sensor measurements of the entity during a monitoring period, as described above.

As further shown in FIG. 5, process 500 may include generating, based on the set of sensor measurements, a prediction for an event associated with the entity (block 530). For example, the device may generate, based on the set of sensor measurements, a prediction for an event associated with the entity, as described above.

As further shown in FIG. 5, process 500 may include transmitting a first set of alerts associated with the event (block 540). For example, the device may transmit a first set of alerts associated with the event, as described above.

As further shown in FIG. 5, process 500 may include receiving, from a second set of monitoring sensors, a set of tracking updates based on transmitting the set of alerts associated with the event (block 550). For example, the device may receive, from a second set of monitoring sensors, a set of tracking updates based on transmitting the set of alerts associated with the event, as described above.

As further shown in FIG. 5, process 500 may include registering a set of attributes, associated with the entity and the set of tracking updates, in a distributed ledger based on receiving the set of tracking updates (block 560). For example, the device may register a set of attributes, associated with the entity and the set of tracking updates, in a distributed ledger based on receiving the set of tracking updates, as described above.

As further shown in FIG. 5, process 500 may include transmitting a second set of alerts associated with the distributed ledger based on registering the set of attributes in the distributed ledger (block 570). For example, the device may transmit a second set of alerts associated with the distributed ledger based on registering the set of attributes in the distributed ledger, as described above.

Process 500 may include additional implementations, such as any single implementation or any combination of implementations described below and/or in connection with one or more other processes described elsewhere herein.

In a first implementation, registering the first set of monitoring sensors comprises receiving information identifying a monitoring sensor, of the first set of monitoring sensors, initiating, based on receiving the information identifying the monitoring sensor, registration of the monitoring sensor in an Internet of Things (IoT) hub, associating device metadata with the monitoring sensor in the IoT hub based on initiating registration of the monitoring sensor in the IoT hub, and instantiating a digital twin of the monitoring sensor based on associating the device metadata with the monitoring sensor in the IoT hub.

In a second implementation, alone or in combination with the first implementation, registering the first set of monitoring sensors comprises registering a location digital twin entity of a location entity, the location digital twin entity having a set of unit digital twin entities and a set of row digital twin entities, and assigning a set of monitoring sensor digital twin entities to the location digital twin entity, each monitoring sensor digital twin entity, of the set of monitoring sensor digital twins, being associated with at least one of a unit digital twin entity, of the set of unit digital twin entities, or a row digital twin entity, of the set of row digital twin entities.

In a third implementation, alone or in combination with one or more of the first and second implementations, receiving the set of sensor measurements comprises identifying a time-based trigger, requesting information identifying the set of measurement sensors from an IoT hub with which a set of digital twins, of the set of measurements sensors, is registered, generating, using a device simulator, telemetry data associated with the set of measurement sensors, and updating stored telemetry of the set of digital twins using the telemetry data and based on the information identifying the set of measurement sensors.

In a fourth implementation, alone or in combination with one or more of the first through third implementations, process 500 includes receiving, based on transmitting the first set of alerts, information indicating completion of the event, storing data associated with the completion of the event based on receiving the information indicating the completion of the event, and deleting one or more digital twin entities associated with the event based on storing the data associated with the completion of the event.

In a fifth implementation, alone or in combination with one or more of the first through fourth implementations, process 500 includes receiving, based on transmitting the first set of alerts, information indicating a tracking update, of the set of tracking updates, wherein the tracking update identifies a new entity associated with the entity, and providing output identifying the tracking update based on receiving the information identifying the tracking update, and wherein registering the set of attributes in the distributed ledger comprises registering the tracking update in the distributed ledger.

In a sixth implementation, alone or in combination with one or more of the first through fifth implementations, generating the prediction for the event comprises obtaining input data from a set of data sources, wherein the set of data sources includes at least one of the first set of monitoring sensors, the second set of monitoring sensors, a packaging platform, a distribution platform, a distributor platform, a retail platform, or an industry consumption platform, and generating the prediction for the event based on the input data.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

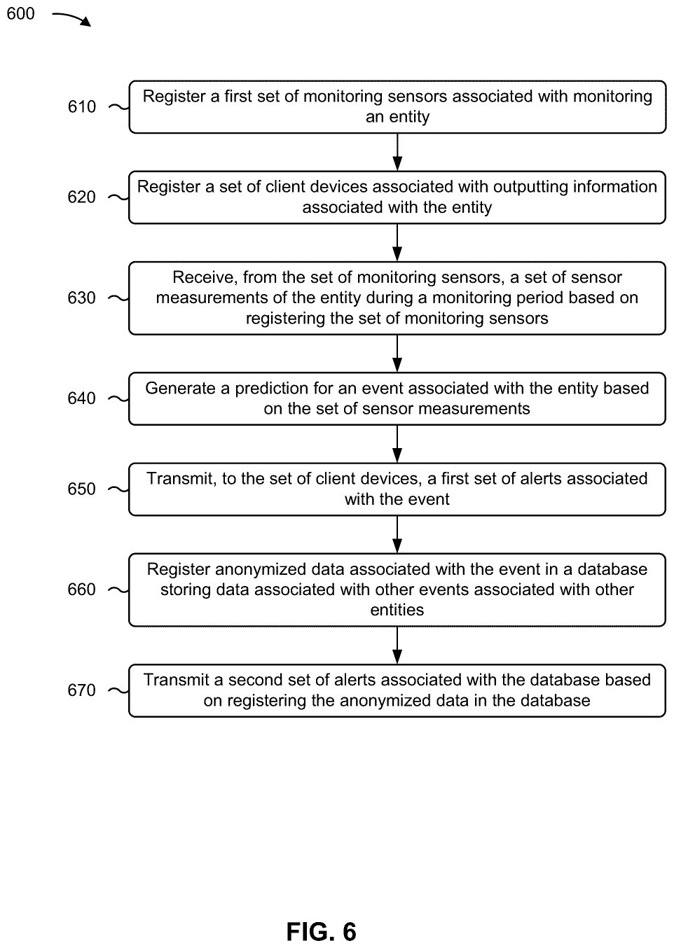

FIG. 6 is a flowchart of an example process 600 associated with using an artificial intelligence architecture for managing a multi-stage process. In some implementations, one or more process blocks of FIG. 6 are performed by a device (e.g., the integration system 301). In some implementations, one or more process blocks of FIG. 6 are performed by another device or a group of devices separate from or including the device, such as a client device (e.g., the client device 330), a server device (e.g., the server device 340), and/or a measurement device (e.g., measurement device 350). Additionally, or alternatively, one or more process blocks of FIG. 6 may be performed by one or more components of device 400, such as processor 420, memory 430, input component 440, output component 450, and/or communication component 460.

As shown in FIG. 6, process 600 may include registering a first set of monitoring sensors associated with monitoring an entity (block 610). For example, the device may register a first set of monitoring sensors associated with monitoring an entity, as described above.

As further shown in FIG. 6, process 600 may include registering a set of client devices associated with outputting information associated with the entity (block 620). For example, the device may register a set of client devices associated with outputting information associated with the entity, as described above.

As further shown in FIG. 6, process 600 may include receiving, from the set of monitoring sensors, a set of sensor measurements of the entity during a monitoring period based on registering the set of monitoring sensors (block 630). For example, the device may receive, from the set of monitoring sensors, a set of sensor measurements of the entity during a monitoring period based on registering the set of monitoring sensors, as described above.

As further shown in FIG. 6, process 600 may include generating a prediction for an event associated with the entity based on the set of sensor measurements (block 640). For example, the device may generate a prediction for an event associated with the entity based on the set of sensor measurements, as described above.

As further shown in FIG. 6, process 600 may include transmitting, to the set of client devices, a first set of alerts associated with the event (block 650). For example, the device may transmit, to the set of client devices, a first set of alerts associated with the event, as described above.

As further shown in FIG. 6, process 600 may include registering anonymized data associated with the event in a database storing data associated with other events associated with other entities (block 660). For example, the device may register anonymized data associated with the event in a database storing data associated with other events associated with other entities, as described above.

As further shown in FIG. 6, process 600 may include transmitting a second set of alerts associated with the database based on registering the anonymized data in the database (block 670). For example, the device may transmit a second set of alerts associated with the database based on registering the anonymized data in the database, as described above.

Process 600 may include additional implementations, such as any single implementation or any combination of implementations described below and/or in connection with one or more other processes described elsewhere herein.

In a first implementation, generating the prediction for the event comprises normalizing the set of sensor measurements to generate a set of normalized sensor measurements, aggregating the set of normalized sensor measurements into a set of time increments, transforming one or more normalized sensor measurements, of the set of normalized sensor measurements and associated with a time increment of the set of time increments, into a transformed format, and generating the prediction using the one or more normalized sensor measurements in the transformed format.

In a second implementation, alone or in combination with the first implementation, process 600 includes receiving a request associated with the entity, accessing a first entity database to obtain data associated with the entity based on receiving the request, communicating with a second entity database to match the data associated with the entity to a record in the second entity database, and storing the data associated with the entity in the second entity database based on matching the data to the record, and registering the first set of monitoring sensors comprises associating the first set of monitoring sensors with the entity based on storing the data associated with the entity in the second entity database.

In a third implementation, alone or in combination with one or more of the first and second implementations, transmitting the first set of alerts comprises generating a report regarding the set of sensor measurements in a reporting system, and causing the reporting system to output the report.

In a fourth implementation, alone or in combination with one or more of the first through third implementations, process 600 includes generating, using a framework, a set of synthetic entities, and generating the prediction comprises generating the prediction based on data associated with the set of synthetic entities.

In a fifth implementation, alone or in combination with one or more of the first through fourth implementations, generating the prediction comprises predicting one or more interventions for the entity based on the other events associated with the other entities, and automatically causing one or more response actions associated with the one or more interventions.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

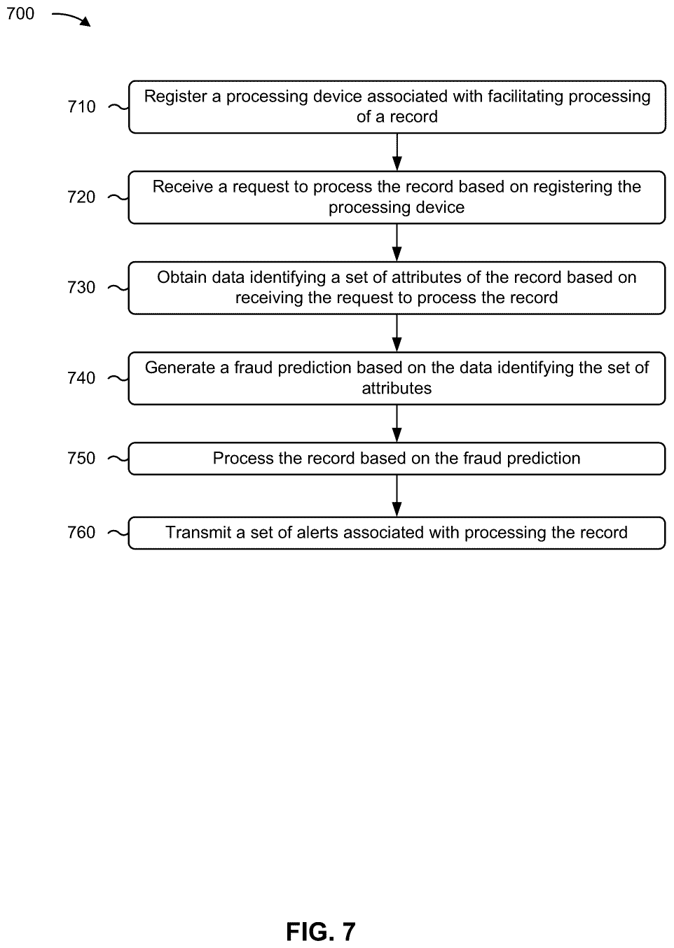

FIG. 7 is a flowchart of an example process 700 associated with using an artificial intelligence architecture for managing a multi-stage process. In some implementations, one or more process blocks of FIG. 7 are performed by a device (e.g., the integration system 301). In some implementations, one or more process blocks of FIG. 7 are performed by another device or a group of devices separate from or including the device, such as a client device (e.g., the client device 330), a server device (e.g., the server device 340), and/or a measurement device (e.g., measurement device 350). Additionally, or alternatively, one or more process blocks of FIG. 7 may be performed by one or more components of device 400, such as processor 420, memory 430, input component 440, output component 450, and/or communication component 460.

As shown in FIG. 7, process 700 may include registering a processing device associated with facilitating processing of a record (block 710). For example, the device may register a processing device associated with facilitating processing of a record, as described above.

As further shown in FIG. 7, process 700 may include receiving a request to process the record based on registering the processing device (block 720). For example, the device may receive a request to process the record based on registering the processing device, as described above.

As further shown in FIG. 7, process 700 may include obtaining data identifying a set of attributes of the record based on receiving the request to process the record (block 730). For example, the device may obtain data identifying a set of attributes of the record based on receiving the request to process the record, as described above.

As further shown in FIG. 7, process 700 may include generating a fraud prediction based on the data identifying the set of attributes (block 740). For example, the device may generate a fraud prediction based on the data identifying the set of attributes, as described above.

As further shown in FIG. 7, process 700 may include processing the record based on the fraud prediction (block 750). For example, the device may process the record based on the fraud prediction, as described above.

As further shown in FIG. 7, process 700 may include transmitting a set of alerts associated with processing the record (block 760). For example, the device may transmit a set of alerts associated with processing the record, as described above.

Process 700 may include additional implementations, such as any single implementation or any combination of implementations described below and/or in connection with one or more other processes described elsewhere herein.

In a first implementation, transmitting the set of alerts comprises transmitting an alert, of the set of alerts, to the processing device to indicate that the record is processed.

In a second implementation, alone or in combination with the first implementation, transmitting the set of alerts comprises transmitting an alert, of the set of alerts, to a backend device to indicate a status of a ledger associated with the record.

In a third implementation, alone or in combination with one or more of the first and second implementations, processing the record comprises updating a distributed ledger based on the record.

In a fourth implementation, alone or in combination with one or more of the first through third implementations, transmitting the set of alerts comprises transmitting an instruction indicating that a shipment is to occur in connection with processing the record.

In a fifth implementation, alone or in combination with one or more of the first through fourth implementations, processing the record comprises executing a set of microservices associated with a set of systems, the set of systems including a merchant system, a card processing system, a card tokenization system, a fraud evaluation system, a notification system, a backend system, or a frontend system.

In a sixth implementation, alone or in combination with one or more of the first through fifth implementations, process 700 includes analyzing a codebase associated with the processing of the record, identifying a security vulnerability in the codebase, and pushing a code modification to the codebase to fix the security vulnerability.

Although FIG. 7 shows example blocks of process 700, in some implementations, process 700 includes additional blocks, fewer blocks, different blocks, or differently arranged blocks than those depicted in FIG. 7. Additionally, or alternatively, two or more of the blocks of process 700 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
registering, by a device, a first set of monitoring sensors associated with monitoring an entity;
receiving, by the device and from the first set of monitoring sensors, and based on registering the first set of monitoring sensors, a set of sensor measurements of the entity during a monitoring period;
generating, by the device and based on the set of sensor measurements, a prediction for an event associated with the entity;
transmitting, by the device, a first set of alerts associated with the event;
receiving, by the device and from a second set of monitoring sensors, a set of tracking updates based on transmitting the set of alerts associated with the event;
registering, by the device, a set of attributes, associated with the entity and the set of tracking updates, in a distributed ledger based on receiving the set of tracking updates; and
transmitting, by the device, a second set of alerts associated with the distributed ledger based on registering the set of attributes in the distributed ledger.

2. The method of claim 1, wherein registering the first set of monitoring sensors comprises:
receiving information identifying a monitoring sensor, of the first set of monitoring sensors,
initiating, based on receiving the information identifying the monitoring sensor, registration of the monitoring sensor in an Internet of Things (IoT) hub;
associating device metadata with the monitoring sensor in the IoT hub based on initiating registration of the monitoring sensor in the IoT hub; and
instantiating a digital twin of the monitoring sensor based on associating the device metadata with the monitoring sensor in the IoT hub.

3. The method of claim 1, wherein registering the first set of monitoring sensors comprises:
registering a location digital twin entity of a location entity, the location digital twin entity having a set of unit digital twin entities and a set of row digital twin entities; and
assigning a set of monitoring sensor digital twin entities to the location digital twin entity, each monitoring sensor digital twin entity, of the set of monitoring sensor digital twins, being associated with at least one of a unit digital twin entity, of the set of unit digital twin entities, or a row digital twin entity, of the set of row digital twin entities.

4. The method of claim 1, wherein receiving the set of sensor measurements comprises:
identifying a time-based trigger;
requesting information identifying the set of measurement sensors from an Internet of Things (IoT) hub with which a set of digital twins, of the set of measurements sensors, is registered;
generating, using a device simulator, telemetry data associated with the set of measurement sensors; and
updating stored telemetry of the set of digital twins using the telemetry data and based on the information identifying the set of measurement sensors.

5. The method of claim 1, further comprising:
receiving, based on transmitting the first set of alerts, information indicating completion of the event;
storing data associated with the completion of the event based on receiving the information indicating the completion of the event; and
deleting one or more digital twin entities associated with the event based on storing the data associated with the completion of the event.

6. The method of claim 1, further comprising:
receiving, based on transmitting the first set of alerts, information indicating a tracking update, of the set of tracking updates, wherein the tracking update identifies a new entity associated with the entity; and
providing output identifying the tracking update based on receiving the information identifying the tracking update; and
wherein registering the set of attributes in the distributed ledger comprises:
registering the tracking update in the distributed ledger.

7. The method of claim 1, wherein generating the prediction for the event comprises:
obtaining input data from a set of data sources,
wherein the set of data sources includes at least one of: the first set of monitoring sensors, the second set of monitoring sensors, a packaging platform, a distribution platform, a distributor platform, a retail platform, or an industry consumption platform; and
generating the prediction for the event based on the input data.

8. A method, comprising:
registering, by a device, a first set of monitoring sensors associated with monitoring an entity;
registering, by the device, a set of client devices associated with outputting information associated with the entity;
receiving, by the device and from the set of monitoring sensors, a set of sensor measurements of the entity during a monitoring period based on registering the set of monitoring sensors;
generating, by the device, a prediction for an event associated with the entity based on the set of sensor measurements;
transmitting, by the device and to the set of client devices, a first set of alerts associated with the event;
registering, by the device, anonymized data associated with the event in a database storing data associated with other events associated with other entities; and
transmitting, by the device, a second set of alerts associated with the database based on registering the anonymized data in the database.

9. The method of claim 8, wherein generating the prediction for the event comprises:
normalizing the set of sensor measurements to generate a set of normalized sensor measurements;
aggregating the set of normalized sensor measurements into a set of time increments;
transforming one or more normalized sensor measurements, of the set of normalized sensor measurements and associated with a time increment of the set of time increments, into a transformed format; and
generating the prediction using the one or more normalized sensor measurements in the transformed format.

10. The method of claim 8, further comprising:
receiving a request associated with the entity;
accessing a first entity database to obtain data associated with the entity based on receiving the request;
communicating with a second entity database to match the data associated with the entity to a record in the second entity database; and
storing the data associated with the entity in the second entity database based on matching the data to the record; and
wherein registering the first set of monitoring sensors comprises:
associated the first set of monitoring sensors with the entity based on storing the data associated with the entity in the second entity database.

11. The method of claim 8, wherein transmitting the first set of alerts comprises:
generating a report regarding the set of sensor measurements in a reporting system; and
causing the reporting system to output the report.

12. The method of claim 8, further comprising:
generating, using a framework, a set of synthetic entities; and
wherein generating the prediction comprises:
generating the prediction based on data associated with the set of synthetic entities.

13. The method of claim 8, wherein generating the prediction comprises:
predicting one or more interventions for the entity based on the other events associated with the other entities; and
automatically causing one or more response actions associated with the one or more interventions.

14. A method, comprising:
registering, by a device, a processing device associated with facilitating processing of a record;
receiving, by the device, a request to process the record based on registering the processing device;
obtaining, by the device, data identifying a set of attributes of the record based on receiving the request to process the record;
generating, by the device, a fraud prediction based on the data identifying the set of attributes;
processing, by the device, the record based on the fraud prediction; and
transmitting, by the device, a set of alerts associated with processing the record.

15. The method of claim 14, wherein transmitting the set of alerts comprises:
transmitting an alert, of the set of alerts, to the processing device to indicate that the record is processed.

16. The method of claim 14, wherein transmitting the set of alerts comprises:
transmitting an alert, of the set of alerts, to a backend device to indicate a status of a ledger associated with the record.

17. The method of claim 14, wherein processing the record comprises:
updating a distributed ledger based on the record.

18. The method of claim 14, wherein transmitting the set of alerts comprises:
transmitting an instruction indicating that a shipment is to occur in connection with processing the record.

19. The method of claim 14, wherein processing the record comprises:
executing a set of microservices associated with a set of systems, the set of systems including a merchant system, a card processing system, a card tokenization system, a fraud evaluation system, a notification system, a backend system, or a frontend system.

20. The method of claim 14, further comprising:
analyzing a codebase associated with the processing of the record;
identifying a security vulnerability in the codebase; and
pushing a code modification to the codebase to fix the security vulnerability.
